(19) United States
(12) Patent Application Publication
(10) Pub. No.: US 2006/0179667 A1
(43) Pub. Date: Aug. 17, 2006

(54) Automatic saw

(76) Inventor: Osamu Izumisawa, Nagano-ken (JP)

Correspondence Address: JORDAN AND HAMBURG LLP, 122 EAST 42ND STREET, SUITE 4000, NEW YORK, NY, 10168, US

(21) Appl. No.: 10/696,875

(22) Filed: Oct. 30, 2003

(30) Foreign Application Priority Data
Aug. 6, 2003 (JP) 2003-287463

(51) Int. Cl. B23D 49/16; B27B 19/00

(52) U.S. Cl. 30/392

(57) ABSTRACT

An automatic saw includes a serrated blade, a blade holder connected to the serrated blade at one end thereof, a plunger arranged at the other end of the blade holder and arranged inside a housing as slidable in the housing, an engagement piece secured to the plunger inside the housing having an engagement elongated hole formed at a side surface of the engagement piece, the engagement hole extending in a direction perpendicular to an extending direction of an axis of the plunger, an air motor rotatable of a crank shaft inserted in and engaged with the engagement hole via a side opening formed in the housing, and a motor housing covering the motor rotatably coupled to the side opening. The rotational force of the crank shaft according to operation of the air motor is converted to back and forth reciprocal movement of the serrated blade via the engagement hole and the engagement piece.

### BACKGROUND OF THE INVENTION

1. Field of the Invention

This invention relates to an automatic saw in which a serrate blade is moved reciprocally in a back and forth direction by an air motor to cut a material to be cut, or a workpiece, such as a metal plate.

2. Description of Related Art

Automatic saws utilizing electrically driven motors as set forth in, e.g., Japanese Patent Application Publications No. Heisei 6-198,601, and No. 2001-62627 have been known conventionally. Automatic saws utilizing air cylinders also exist. In such a product utilizing an air cylinder, the cylinder contains a piston movable back and forth in an axial direction of the serrate blade, and an air introduction route is arranged on the opposite ends of the cylinder via the piston. Air is alternatively introduced into the cylinder from the air introduction route to move the piston reciprocally back and forth in the axial direction of the serrate blade, thereby moving reciprocally back and forth the serrate blade to cut a workpiece such as a metal plate.

To move the piston reciprocally in the back and forth direction by introduction of the air, a pair of air introduction openings is formed, and any one of the air introduction opening pair is opened whereas a switching valve to shut the other is mounted movably back and forth relatively to the piston. When air is introduced into the cylinder from the one of the air introduction routes, one of the air introduction openings is shut by the switching valve from movement of the piston to the other side, thereby opening the other air introduction opening. By exhausting the air on the other side from the other air introduction opening, the piston further moves toward the other side. Subsequently, when air introduction from one of the air introduction routes is ceased whereas air is introduced from the other of the air introduction routes into the cylinder, the piston moves to the one side, and the air introduction opening on the other side is shut by the switching valve to open the air introduction opening on the one side. The piston is further moved toward the one side by exhausting the air on the one side out of the air introduction opening on the one side.

Thus, by alternative air introductions from both of the air introduction routes into the cylinder, the piston is moved reciprocally back and forth, and consequently, the serrate blade is moved reciprocally back and forth in association with the piston, thereby cutting the workpiece.

The switching valve, however, may fall in a situation that the back and forth movement correlative between the switching valve and the piston becomes impossible due to influences from frictional force or the like during repetitive reciprocal movement of the piston because the switching valve is inserted in the piston in being movable correlatively to each other. Therefore, switching of opening and closing of both of the air introduction openings cannot be done, thereby rendering the piston impossible to move reciprocally back and forth, and thereby rendering the serrate blade impossible to cut the workpiece. In such a case, the user manually shakes the automatic saw in the back and forth direction to revive the back and forth movement correlative between the switching valve and the piston and to allow the air introduction opening of the piston to be open and closed, and the user has to revive the back and forth reciprocal movement of the piston by introduction and exhaustion of air, so that such operation can be done not easily and reduces the workability.

To solve the above problem, it is an object of the invention to provide an automatic saw operating without ceasing back and forth reciprocal movement of a serrate blade and improving workability during cutting operation of a workpiece as maintainable of smooth operation. It is also an object of the invention to provide an automatic saw of such a high quality with a simple structure and lower costs.

### SUMMARY OF THE INVENTION

To solve the above problems, this invention is constituted of a serrate blade; a blade holder connected to the serrate blade at one end thereof, a plunger arranged at the other end of the blade holder and arranged inside a housing as slidable in the housing; an engagement piece secured to the plunger inside the housing having an engagement long hole formed at a side surface of the engagement piece, the engagement long hole extending in a direction perpendicular to an extending direction of an axis of the plunger; an air motor rotatable of a crank shaft inserted in and engaged with the engagement long hole via the a side opening formed in the housing; and a motor housing covering the motor rotatably coupled to the side opening, wherein rotational force of the crank shaft according to operation of the air motor is converted to back and forth reciprocal movement of the serrate blade via the engagement long hole and the engagement piece.

According to a preferred embodiment, the housing is capable of reducing an inner diameter of the side opening of an outer peripheral wall thereof by forming a slit at the outer peripheral wall extending in an axial direction from the side opening, and wherein, where coupled to the side opening, the motor housing is immobilized as an outer periphery of the motor housing is fastened to an inner surface of the side opening when the inner diameter of the side opening is reduced and is arranged as adjustable of a positional angle of the motor housing with respect to the axial direction of the serrate blade when the inner diameter of the side opening is widened.

The housing may secure a support placed by a side surface of the serrate blade to render impossible contact between a portion of the serrate blade placed by the support and a workpiece during cutting operation of the workpiece done by the serrate blade, and wherein a portion of the serrate blade to be in contact with the workpiece is adjustable by rendering the support movable in the axis direction of the serrate blade.

This invention thus structured can maintain the smooth back and forth reciprocal movement of the serrate blade for a long period of time by converting the rotational force of the crank shaft in association with the operation of the air motor into the back and forth reciprocal movement of the serrate blade via the engagement long hole and the engagement piece. Therefore, the automatic saw is free from unexpected stops of the cutting operation during use, can smoothly cut the workpiece with the serrate blade, and makes itself easily used. High quality automatic saws can be produced with easy assembling technique and lower costs because the saws are simply constituted solely from engagements of the engagement piece coupled to the serrate blade via the plunger and the crank shaft of the air motor.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is an exploded perspective view showing an automatic saw according to an embodiment of the invention;

FIG. 2 is a plan view showing a housing to which a serrate blade is attached;

FIG. 3 is a perspective view showing an assembled state of the automatic saw according to the embodiment;

FIG. 4 is a plan view showing a motor housing and the housing which are coupled with an arbitrary angle; and

FIG. 5 is a plan view showing a moving state of a support.

### DETAILED DESCRIPTION OF PREFERRED EMBODIMENTS

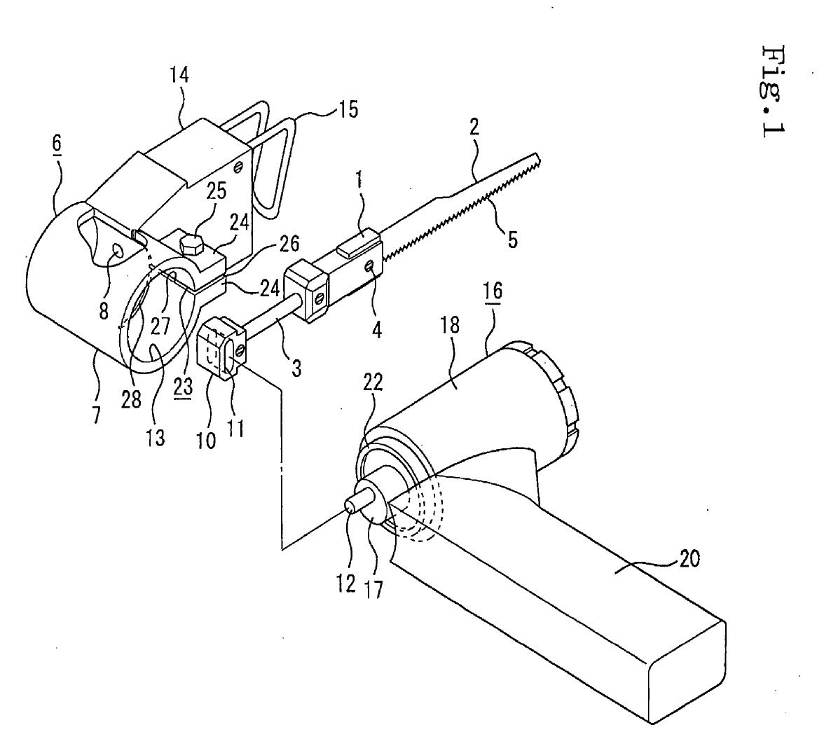

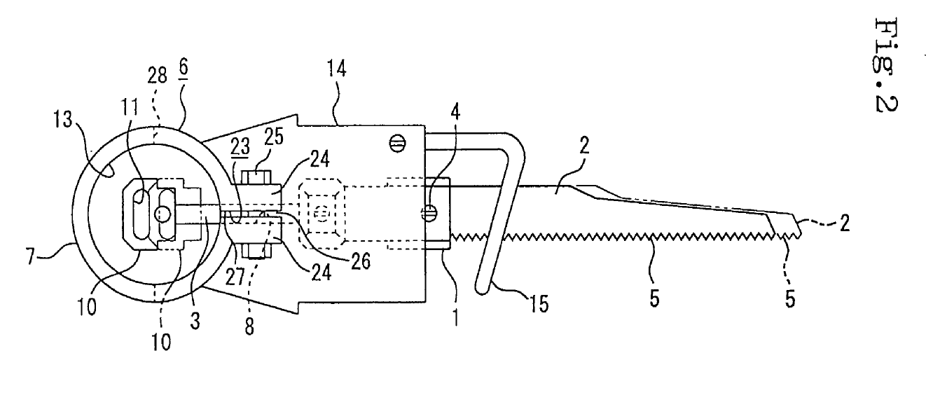

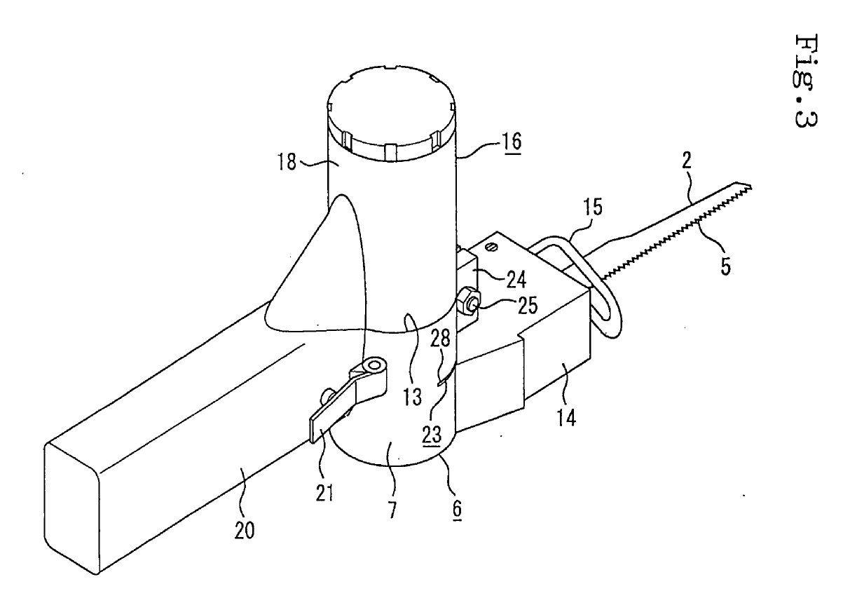

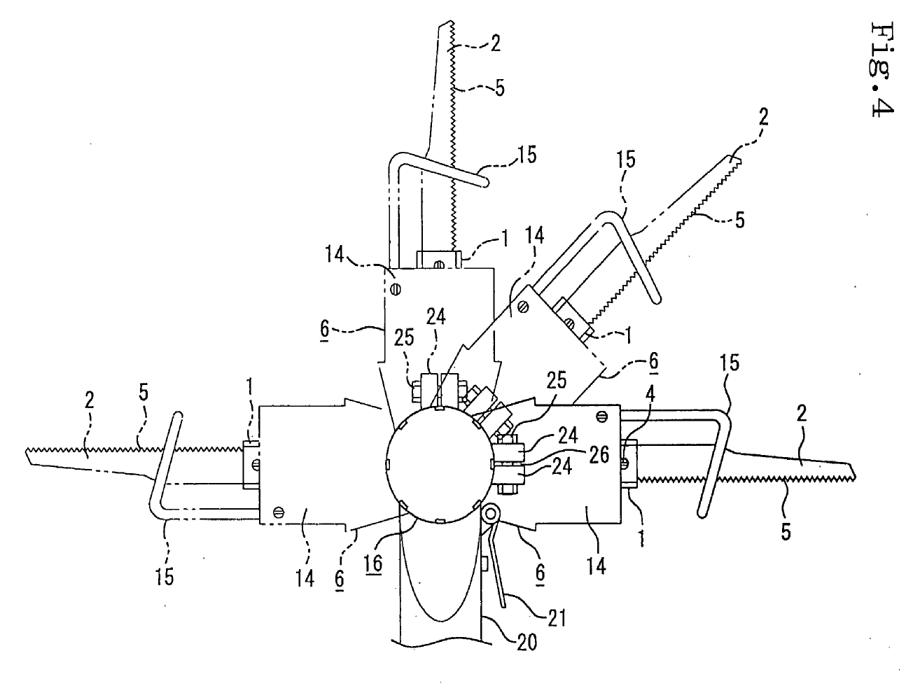

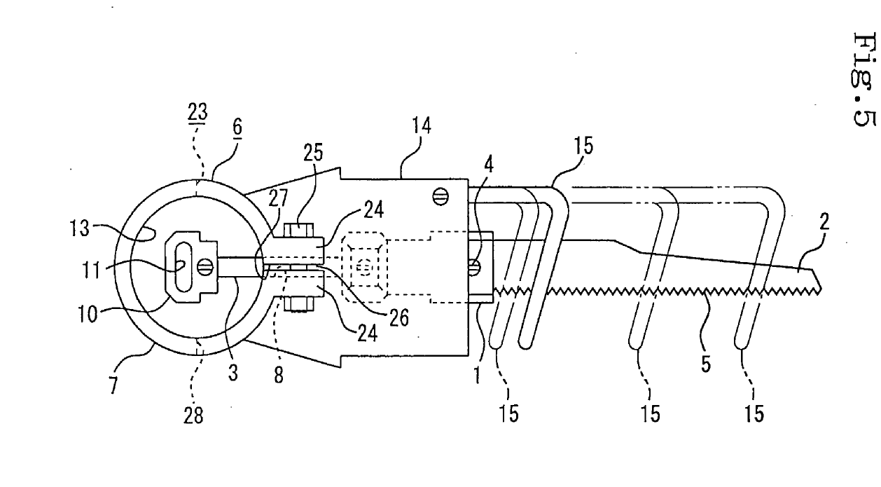

Hereinafter, with reference to the drawings, preferred embodiments according to the invention are described. FIG. 1 is an exploded perspective view showing an automatic saw; FIG. 2 is a plan view showing a housing, an engagement piece contained in the housing, and a serrate blade attached coupled to the engagement piece via a plunger; FIG. 3 is a perspective view showing the automatic saw in a usable state where a motor housing and the housing are coupled; FIG. 4 shows a state that the serrate blade can be placed with a proper angle to a grip of the motor housing held by the user where the motor housing and the housing are pivotally movable to as well as secured to each other; and FIG. 5 is a plan view showing a support movable in the back and forth reciprocal direction of the serrate blade.

In the drawings, the numeral 1 is a blade holder, and one end of the holder is coupled to a serrate blade 2 whereas the other end is securely coupled to a plunder 3 in a bar shape. The serrate blade 2 is detachably attached to the blade holder 1 with an attachment screw 4 to be replaced, and a blade 5 for cutting workpiece is formed on a one side. The plunger 3 coupled to the other end of the blade holder 1 is inserted in a slidable manner in an insertion hole 8 formed in an outer peripheral wall 7 formed in a cylindrical shape at a housing 6 as shown in FIG. 1 and FIG. 2, and an engagement piece 10 is secured to the other end of the plunger 3 disposed in the housing 6 as shown in FIG. 2. An engagement long hole 11 is formed on a side surface of the engagement piece 10 as extending in a direction perpendicular to the axis of the plunger 3, and a crank shaft 12 rotatable by an air motor described below is inserted in and engaged with the engagement long hole 11 via a side opening 13 formed in the outer peripheral wall 7 of the housing 6.

The housing 6 is formed with a cylinder-shaped cover portion 14 in a projecting manner on an opening side of the insertion hole 8, and the cover portion 14 protects in a covering manner the plunger 3 and the blade holder 1. A hook-shaped support 15 is secured to the cover portion 14 as to face to both sides of the serrate blade 2, and when the serrate blade 2 cuts the workpiece, the blade 5 placed between a position at which the support 15 is placed and the blade holder 1 is made impossible to contact with the workpiece, thereby preventing the saw from being used for any portion other than the portions to be cut. The support 15 is formed to be movable back and forth in the back and forth reciprocal direction of the serrate blade 2 by a proper means as shown in FIG. 5 in this embodiment, and is adjustable arbitrarily of the position of the blade 5 of the serrate blade 2 contacting to the workpiece. With such a structure, it is not needed to replace the entire serrate blade 2 due to wearing of a part of the blade 5 of the serrate blade 2, so that cutting work using the entire blade 5 of the serrate blade 2 can be done, and so that the serrate blade 2 can be used economically.

In a meanwhile, a motor housing 16 coupled rotatably and securely to a side opening 13 of the housing 6 has, as shown in FIG. 1 and FIG. 2, a motor containing section 18 formed in a cylindrical shape containing an air motor, not shown, and is formed with a grip portion 20 used for being held by the user of the automatic saw extending in a direction perpendicular to the axis of the motor containing section 18. The grip portion 20 is coupled to an air supplying section, not shown, via an air hose, not shown, or the like and, by pressing a slot lever 21 formed on a side surface, releases an openable valve, not shown, to introduce air from the air supplying portion, not shown, to allow the operation of the air motor. A motor shaft 17 rotating by operation of the air motor is formed at the air motor to rotate, and the motor shaft 17 is projected out of the motor containing section 18. The crank shaft 12 is formed as projecting at an eccentric position of the motor shaft 17, and the crank shaft 12 is rotatable in an eccentric manner according to the operation of the air motor. A cylindrical engagement projection 22 is formed for engaging with the inner portion of the side opening 13 of the housing 6 at an outer periphery on a side of the crank shaft 12 of the motor containing section 18.

The housing 6 engaging to the engagement projection 22 has, at the outer peripheral wall 7, a vertical slit 27 extending in the axial direction from the side of the side opening 13 to the vicinity of the top surface of the cover portion 14 as shown in FIG. 1 to FIG. 3, and a transverse slit 28 extending in one and the other circumferential directions of the outer peripheral wall 7 perpendicular to the vertical slit 27 from the proximal end of the vertical slit 27, thereby forming a splitting slit 23 extending in a reverse letter-T shape as a side shape. By placing the splitting slit 23, the inner diameter of the outer peripheral wall 7 located on a side of the side opening 13 can be decreased and increased. At the splitting slit 23, a pair of flanges 24 is formed as projecting uprightly from the outer peripheral wall 7 via a clamping gap 26 on the respective sides astride the vertical slit 27. By fastening the pair of the flanges 24 by a fastening screw 25, the inner diameter of the side opening can be reduced, and the state of a reduced diameter can be maintained.

The cylindrical engagement projection 22 of the motor containing section 18 is engaged with the outer peripheral wall 7 thus structured and formed on a side of the side opening 13, and the crank shaft 12 is engaged with the engagement long hole 11 of the engagement piece 10. Subsequently, the flanges 24 are fastened with the fastening screw 25 to reduce the inner diameter on the side of the side opening 13, so that the outer periphery of the engagement projection 22 is strongly fastened to the inner peripheral surface of the side opening 13, and so that the motor housing 16 is connected to the housing as not to be rotatable.

Conversely, by loosing the fastening screw 25, the inner diameter on the side of the side opening is widened, thereby allowing the motor housing 6 to be taken out of the housing 6 easily. Furthermore, because the outer peripheral wall 7 of the housing 6 and the motor containing section 18 of the motor housing 16 are also in a cylindrical shape, those can be rotated freely in the circumferential direction to render the disposed angle of the motor housing 16 freely adjustable in the right and left direction, about 90 degrees, with respect to the axial direction of the serrate blade 2 as shown with the solid line and the double dotted line in FIG. 4. The housing 6 and the motor housing 16 can be immobilized and used with a desired angle by fastening the fastening screw 25 at those rotational positions and by reducing the inner diameter on the side of the side opening 13 of the outer peripheral wall 7.

It is to be noted that although in this embodiment the splitting slit 23 extending in the reverse letter-T shape as the side surface shape is formed with the vertical slit 27 formed at the outer peripheral wall 7 and the transverse slit 28 extending in one and the other circumferential directions from the proximal end of the vertical slit 27, a splitting slit extending in a letter-L shape as the side surface shape made of a vertical slit 27 and a transverse slit 28 extending in either one of the circumferential directions can be used as far as the inner diameter on the side of the side opening is reducible, and also, a splitting slit 23 extending in a letter-I as the side surface shape made of the vertical slit 27 can be used. Not the connection with the splitting slit 23, the flange 24, or the fastening screw 25 but any other means can connect the motor housing 6 with the housing 6 as far as the motor housing 16 can be connected rotatably and fixedly.

When the housing 6 and the motor housing 16 are connected to each other, these are necessarily connected upon positioning the crank shaft 12 of the air motor to match the engagement long hole 11 of the engagement piece 10 as described above. Because this engagement is made between the crank shaft 12 rotating in a circled manner around the motor shaft 17 as the center and the engagement long hole 11, it is can be done easily by rotating the crank shaft 12 properly in the circumferential direction to match the engagement long hole 11 or conversely by moving back and forth the engagement piece 10 in matching the position of the crank shaft 12. With such an adjusting means, the crank shaft 12 and the engagement long hole 11 are positionally aligned and can be engaged to each other even where the housing 6 and the motor housing 16 are coupled with any angle.

Since the workpiece such as a metal plate or the like is cut in use of the automatic saw as described above, the crank shaft 12 is eccentrically rotated by operation of the air motor where air is supplied to the air motor from the air supplying portion upon pushing the throttle lever 21. This rotational movement of the crank shaft 12 is converted to the back and forth reciprocal movement of the engagement piece 10 engaging to the crank shaft 12 via the engagement long hole 11. Because the serrate blade 2 connected via the plunger 3 moves reciprocally back and forth according to the back and forth reciprocal movement of the engagement piece 10, the workpiece can be cut by contacting the blade 5 of the serrate blade 2 with the workpiece.

The back and forth reciprocal movement of the serrate blade 2 is in proportion to the distance of the crank shaft 12 from the motor shaft 17, or namely the size of the circle depicted as a trace by the crank shaft 12. That is, the distance of the back and forth reciprocal movement of the engagement piece 10 can be made longer by rotating the crank shaft 12 largely in rendering longer the distance of the crank shaft 12 to the motor shaft 17, thereby moving the serrate blade 2 largely back and forth reciprocally. Conversely, the distance of the back and forth reciprocal movement of the engagement piece 10 can be made shorter by rotating the crank shaft 12 compactly in rendering shorter the distance of the crank shaft 12 to the motor shaft 17, thereby compactly moving the serrate blade 2 back and forth reciprocally. It is to be noted that the length of the engagement long hole 11 of the engagement piece 10 is adjusted in corresponding to the diameter of the circle depicted by the crank shaft 12. It is desired that the distance of the back and forth reciprocal movement of the serrate blade 2 set by adjusting the eccentric distance of the crank shaft 12 and the length of the engagement long hole 11, is properly adjusted according to cutting objects and kinds of the workpiece.

Because large shearing force is obtained by using the air motor, the workpiece can be cut excellently solely by back and forth reciprocally moving the serrate blade 2. Therefore, the engagement long hole 11 can be made short, and the engagement piece 10 can be made smaller, so that various parts such as the housing 6 containing the engagement piece 10 can be made smaller. Consequently, a compact automatic saw is obtainable in having excellency in cutting workpiece.

In this automatic saw, the rotational force of the crank shaft 12 in accompanied with the operation of the air motor is converted to the back and forth reciprocal movement of the engagement piece 10 via the engagement long hole 11 to allow the serrate blade 2 moving reciprocally back and forth, so that disorders such that the operation of the serrate blade ceases due to a conventional air cylinder, unlikely occur, and so that the cutting work of the workpiece can be done effectively. Because the connection angle between the motor housing 16 and the housing 6 can be adjusted arbitrarily, the cutting work can be done in placing the serrate blade 2 at an angle easy to be used by the user, so that the workability can be improved further. Such a product excellent in cutting ability can be produced easily with the simply shaped parts and the easy structure, thereby providing inexpensive products.

The foregoing description of a preferred embodiment of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined by the claims set forth below.

What is claimed is:

1. An automatic saw comprising:
a serrate blade;
a blade holder connected to the serrate blade at one end thereof;
a plunger arranged at the other end of the blade holder and arranged inside a housing as slidable in the housing;
an engagement piece secured to the plunger inside the housing having an engagement long hole formed at a side surface of the engagement piece, the engagement long hole extending in a direction perpendicular to an extending direction of an axis of the plunger;
an air motor rotatable of a crank shaft inserted in and engaged with the engagement long hole via the a side opening formed in the housing; and
a motor housing covering the motor rotatably coupled to the side opening,
wherein rotational force of the crank shaft according to operation of the air motor is converted to back and forth reciprocal movement of the serrate blade via the engagement long hole and the engagement piece.

2. The automatic saw according to claim 1, wherein the housing is capable of reducing an inner diameter of the side opening of an outer peripheral wall thereof by forming a slit at the outer peripheral wall extending in an axial direction from the side opening, and wherein, where coupled to the side opening, the motor housing is immobilized as an outer periphery of the motor housing is fastened to an inner surface of the side opening when the inner diameter of the side opening is reduced and is arranged as adjustable of a positional angle of the motor housing with respect to the axial direction of the serrate blade when the inner diameter of the side opening is widened.

3. The automatic saw according to claim 1 or claim 2, wherein the housing secures a support placed by a side surface of the serrate blade to render impossible contact between a portion of the serrate blade placed by the support and a workpiece during cutting operation of the workpiece done by the serrate blade, and wherein a portion of the serrate blade to be in contact with the workpiece is adjustable by rendering the support movable in the axis direction of the serrate blade.
